(19) United States
(12) Patent Application Publication
(10) Pub. No.: US 2025/0098039 A1
(43) Pub. Date: Mar. 20, 2025

(54) INDUCTION HEATING TYPE COOKTOP

(71) Applicant: LG Electronics Inc., Seoul (KR)

(72) Inventors: Chuhyoung CHO, Seoul (KR); Seongho SON, Seoul (KR); Younghwan KWACK, Seoul (KR); Seonho JEON, Seoul (KR); Jongseong JI, Seoul (KR)

(21) Appl. No.: 18/726,554

(22) PCT Filed: May 25, 2022
(86) PCT No.: PCT/KR2022/007459

§ 371 Date: Jul. 3, 2024

(30) Foreign Application Priority Data
Jan. 7, 2022 (KR) 10-2022-0002488

(51) Int. Cl. H05B 6/12; H05B 6/10

(52) U.S. Cl. CPC H05B 6/1272; H05B 6/105

(57) ABSTRACT

Provided is an induction heating type cooktop provided with an intermediate heating body to improve heating efficiency with respect to a magnetic body and a nonmagnetic body. The induction heating type cooktop includes an upper plate, on which an object to be heated is disposed, an intermediate heating body installed on the upper plate, a working coil configured to generate magnetic fields for heating the object to be heated, an inverter driven to supply current to the working coil, and a shielding coil in which the current is selectively induced according to kinds of object to be heated.

### TECHNICAL FIELD

The present disclosure relates to an induction heating type cooktop. More particularly, the present disclosure relates to an induction heating type cooktop, which is capable of heating all of a magnetic body and a nonmagnetic body.

### BACKGROUND ART

Various types of cooking appliances are used to heat food at home or in the restaurant. According to the related art, a gas stove using gas as a fuel has been widely used. However, recently, devices for heating an object to be heated, for example, a cooking vessel such as a pot, have been spread using electricity instead of the gas.

A method for heating the object to be heated using electricity is largely divided into a resistance heating method and an induction heating method. The electrical resistance method is a method for heating an object to be heated by transferring heat generated when electric current flows through a metal resistance wire or a non-metal heating body such as silicon carbide to the object to be heated (e.g., a cooking vessel) through radiation or conduction. In the induction heating method, when high-frequency power having a predetermined intensity is applied to a coil, eddy current is generated in the object to be heated using magnetic fields generated around the coil so that the object to be heated is heated.

Recently, most of the induction heating methods are applied to cooktops.

However, in the case of a cooktop to which the induction heating method is applied, there is a limitation in that only a magnetic body is heated. That is, when a nonmagnetic body (e.g., heat-resistant glass, ceramics, etc.) is disposed on the cooktop, there is a problem that the cooktop to which the induction heating method is applied does not heat the object to be heated.

To improve the limitation of the induction heating type cooktop, the cooktop may include an intermediate heating body to which eddy current is applied, and the nonmagnetic body may be heated through the intermediate heating body. However, in this case, even when the cooktop heats the magnetic body, there is a limitation in that heating efficiency is lowered because a portion of magnetic fields is coupled to the intermediate heating body. When the intermediate heating body is formed, there is a limitation in that an output to the non-magnetic body is very low.

### DISCLOSURE OF INVENTION

### Technical Problem

Embodiment provides an induction heating type cooktop including an intermediate heating body to improve heating efficiency with respect to each of a magnetic body and a nonmagnetic body.

### Solution to Problem

An induction heating type cooktop according to an embodiment may include a separate shielding coil to change a magnetic field concentration area according to an object to be heated.

An induction heating type cooktop includes: an upper plate, on which an object to be heated is disposed; an intermediate heating body installed on the upper plate: a working coil configured to generate magnetic fields for heating the object to be heated; an inverter driven to supply current to the working coil; and a shielding coil in which the current is selectively induced according to kinds of object to be heated.

When the object to be heated is a magnetic body, the inducted current may flow in the shielding coil.

When the object to be heated is a magnetic body, the shield coil may be configured to generate magnetic fields that are offset by the magnetic fields generated in the working coil.

When the object to be heated is a nonmagnetic body, the current may not be induced in the shielding coil.

The induction heating type cooktop may further include a switch configured to selectively induce the current into the shielding coil.

The switch may be connected to each of one end and the other end of the shielding coil.

The switch may be turned on when the object to be heated is a magnetic body, and the switch may be turned off when the object to be heated is a nonmagnetic body.

The working coil may include a first working coil and a second working coil, which are disposed parallel to each other in a left and right direction, and the inverter may be configured to control current flowing in the first working coil and the second working coil.

The shielding coil may be disposed in a shape in which the induced current flows when current having the same phase flows in the first working coil and the second working coil.

The shielding coil may be disposed outside the first working coil and the second working coil so that the first working coil and the second working coil are disposed inside the shielding coil.

The magnetic fields generated in the shielding coil may be offset by the magnetic fields that leak out of a heating area.

The shielding coil may be disposed in a shape in which the induced current flows when current having an out-of-phase flows in the first working coil and the second working coil.

The shielding coil may be disposed so that the induced current passes through an outer circumference of the first working coil to flow along an outer circumference of the second working coil.

The magnetic fields generated in the shielding coil may be offset by the magnetic fields generated in the working coil to pass through the intermediate heating body.

The shielding coil may be disposed between the upper plate and the working coil.

### ADVANTAGEOUS EFFECTS OF INVENTION

According to the embodiment of the present disclosure, there may be the advantage that the induction heating type cooktop further includes the shielding coil to acquire or maximize the phase control effect.

According to the embodiment of the present disclosure, it may be possible to acquire or maximize the phase control effect only by applying the shielding coil.

### BRIEF DESCRIPTION OF DRAWINGS

FIG. 1 is a view for explaining an induction heating type cooktop according to an embodiment.

FIG. 2 is a cross-sectional view illustrating the induction heating type cooktop and an object to be heated according to an embodiment.

FIG. 3 is a cross-sectional view illustrating an induction heating type cooktop and an object to be heated according to another embodiment.

FIGS. 4 and 5 are views for explaining a change in impedance between an intermediate heating body and the object to be heated according to kinds of objects to be heated.

FIGS. 6 and 7 are circuit diagrams of an induction heating type cooktop according to a first embodiment.

FIG. 8 is a control block diagram illustrating a method for controlling a switch depending on an object to be heated in an induction heating type cooktop according to an embodiment.

FIG. 9 is a flowchart illustrating a method for controlling the switch according to the object to be heated in the induction heating type cooktop according to an embodiment.

FIG. 10 is a circuit diagram of an induction heating type cooktop according to a second embodiment.

FIG. 11 is a view illustrating a state in which a shielding coil is disposed in the induction heating type cooktop according to the second embodiment.

FIG. 12 is a view illustrating a state in which current is induced to the shielding coil when the shielding coil is disposed as illustrated in (a) of FIG. 11.

FIG. 13 is a view illustrating a state in which current is induced to the shielding coil when the shielding coil is disposed as illustrated in (b) of FIG. 11.

### BEST MODE FOR CARRYING OUT THE INVENTION

Hereinafter, embodiments relating to the present disclosure will be described in detail with reference to the accompanying drawings. Furthermore, terms, such as a “module” ad a “unit”. are used for convenience of description, and they do not have different meanings or functions in themselves.

Hereinafter, an induction heating type cooktop and an operation method thereof according to an embodiment of the present disclosure will be described. For convenience of description, the “induction heating type cooktop” is referred to as a “cooktop”.

Hereinafter, an induction heating type cooktop according to an embodiment of the present disclosure will be described.

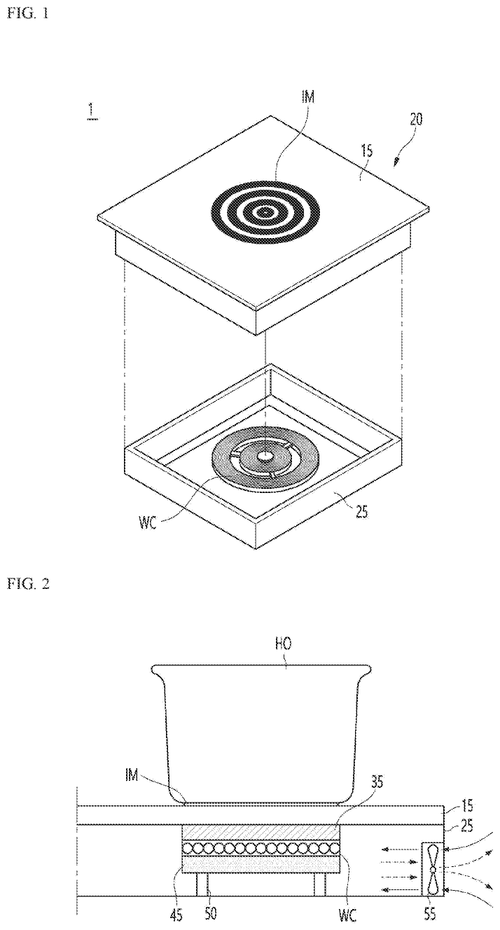

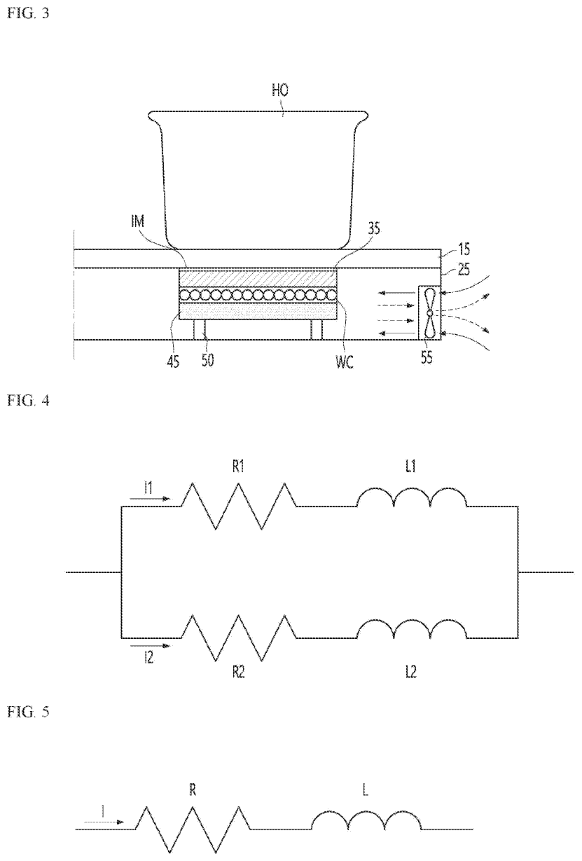

FIG. 1 is a view for explaining an induction heating type cooktop according to an embodiment. FIG. 2 is a cross-sectional view illustrating the induction heating type cooktop and an object to be heated according to an embodiment. FIG. 3 is a cross-sectional view illustrating an induction heating type cooktop and an object to be heated according to another embodiment.

First, referring to FIG. 1. an induction heating type cooktop 1 according to an embodiment of the present disclosure includes a case 25, a cover plate 20, a working coil WC, and an intermediate heating body IM.

The working coil WC may be installed in the case 25.

For reference. in the case 25, various devices related to driving of the working coil (for example, a power supply that provides AC power. a rectifier that rectifies the AC power of the power supply into DC power, an inverter that converts the DC power rectified by the rectifier into resonance current through a switching operation to provides the resonance current to the working coil. a control module that controls operations of various devices within the induction heating type cooktop 1, a relay or semiconductor switch that tums on or off the working coil, etc.) in addition the working coils WC1 and WC2 may be installed in the case 25.

The cover plate 20 may be coupled to an upper end of the case 25 and be provided with an upper plate 15 on which an object to be heated (not shown) is disposed on a top surface thereof.

Specifically, the cover plate 20 may include the upper plate 15 for placing an object to be heated, such as a cooking vessel. thereon. That is, an object to be heated may be placed on the upper plate 15.

Here. the upper plate 15 may be made of, for example, a glass material (e.g., ceramics glass).

In addition, the upper plate 15 may be provided with an input interface (not shown) that receives an input from a user to transmit the input to a control module (not shown) for an input interface Of course, the input interface may be provided at a position other than the upper plate 15.

For reference, the input interface may be a module for inputting a desired heating intensity or driving time of the induction heating type cooktop 1 and may be variously implemented with a physical button or a touch panel. Also. the input interface may include, for example, a power button. a lock button, a power level adjustment button (+, −), a timer adjustment button (+,-), a charging mode button, and the like. In addition, the input interface may transmit the input received from the user to the control module for the input interface (not shown), and the control module for the input interface may transmit the input to the aforementioned control module (i.e., the control module for the inverter). In addition, the aforementioned control module may control the operations of various devices (e.g., the working coils) based on the input (i.e., a user input) provided from the control module for the input interface.

Whether the working coil WC is driven and the heating intensity (i.e., thermal power) may be visually displayed on the upper plate 15 in a shape of a crater. The shape of the crater may be indicated by an indicator (not shown) constituted by a plurality of light emitting devices (e.g., LEDs) provided in the case 25.

The working coil WC may be installed inside the case 25 to heat the object to be heated.

Specifically, the working coil WC may be driven by the aforementioned control module (not shown), and when the object to be heated is disposed on the upper plate 15, the working coil WC may be driven by the control module.

In addition, the working coil WC may directly heat an object to be heated (i.e., a magnetic body) having magnetism and may indirectly heat an object to be used (i.e., a nonmagnetic body) through an intermediate heating body IM that will be described later.

In addition, the working coil WC may heat the object to be heated in an induction heating manner and may be provided to overlap the intermediate heating body IM in a longitudinal direction (i.e., a vertical direction or an upward and downward direction).

For reference, although the structure in which one working coil WC is installed in the case is illustrated in FIG. 1, the embodiment is not limited thereto. That is, one or more working coils WC may be installed in the case 25. The intermediate heating body IM may be installed to correspond to the working coil WC. The number of intermediate heating bodies IM and the number of working coils WC may be the same.

The intermediate heating body IM may be installed on the upper plate 15. The intermediate heating body IM may be applied on the upper plate 15 to heat the nonmagnetic body among the objects to be heated. The intermediate heating body IM may be inductively heated by the working coil WC.

The intermediate heating body IM may be disposed on a top surface or a bottom surface of the upper plate 15. For example, as illustrated in FIG. 2, the intermediate heating body IM may be installed on the top surface of the upper plate 15, or as illustrated in FIG. 3, the intermediate heating body IM may be installed on the bottom surface of the upper plate 15.

The intermediate heating body IM may be provided to overlap the working coil WC in the longitudinal direction (i.e., the vertical direction or the upward and downward direction). Thus, the heating of the objects to be heated may be possible regardless of the arrangement positions and types of the objects to be heated.

Also, the intermediate heating body IM may have at least one of magnetic and nonmagnetic properties (i.e., a magnetic property, a nonmagnetic property, or both the magnetic and nonmagnetic properties).

In addition, the intermediate heating body IM may be made of, for example, a conductive material (e.g., aluminum), and as illustrated in the drawings, a plurality of rings having different diameters may be installed on the upper plate 15 in a repeated shape, but is not limited thereto. That is, the intermediate heating body IM may be made of a material other than a conductive material. Also, the intermediate heating body IM may be provided in a shape other than the shape in which the plurality of rings having different diameters are repeated.

For reference, although one intermediate heating body IM is illustrated in FIGS. 2 and 3, the embodiment is not limited thereto. That is, a plurality of thin films may be installed, but for convenience of description, one intermediate heating body IM may be installed as an example.

More details of the intermediate heating body IM will be described later.

Next, referring to FIGS. 2 and 3, the induction heating type cooktop 1 according to an embodiment of the present disclosure may further include at least some or all of an insulating material 35, a shielding plate 45, a support member 50, and a cooling fan 55.

The insulating material 35 may be provided between the upper plate 15 and the working coil WC.

Specifically, the insulating material 35 may be mounted under the upper plate 15, and the working coil WC may be disposed below the insulating material 35.

The insulating material 35 may prevent heat generated while the intermediate heating body IM or the object HO to be heated by the driving of the working coil WC from being transmitted to the working coil WC.

That is, when the intermediate heating body IM or the object HO to be heated is heated by electromagnetic induction of the working coil WC, the heat of the intermediate heating body IM or the object HO to be heated may be transferred to the upper plate 15, and then, the heat of the upper plate 15 may be transferred to the working coil WC again to damage the working coil WC.

The insulating material 35 may block the heat transferred to the working coil WC as described above to prevent the working coil WC from being damaged by the heat, and furthermore, prevent heating performance of the working coil WC from being deteriorated.

For reference, although it is not an essential component, a spacer (not shown) may be installed between the working coil WC and the insulating material 35.

Specifically, the spacer (not shown) may be inserted between the working coil WC and the insulating material 35 so that the working coil WC and the insulating material 35 are not in directly contact with each other. Thus, the spacer (not shown) may prevent the heat generated while the intermediate heating body IM or the object HO to be heated by the driving of the working coil WC from being transmitted to the working coil WC through the insulating material 35.

That is, since the spacer (not shown) partially shares the role of the insulating material 35, a thickness of the insulating material 35 may be minimized, and thus, an interval between the object HO to be heated and the working coil WC may be minimized.

In addition, the spacer (not shown) may be provided in plurality, and the plurality of spacers may be disposed to be spaced apart from each other between the working coil WC and the insulating material 35. Thus, air suctioned into the case 25 by a cooling fan 55 to be described later may be guided to the working coil WC by the spacers (not shown).

That is, the spacers may guide the air introduced into the case 25 by the cooling fan 55 so as to be properly transferred to the working coil WC, thereby improving cooling efficiency of the working coil WC.

The shielding plate 45 may be mounted under the working coil WC to block magnetic fields generated downward when the working coil WC is driven.

Specifically, the shielding plate 45 may block the magnetic fields generated downward when the working coil WC is driven and may be supported upward by the support member 50.

The support member 50 may be installed between a bottom surface of the shielding plate 45 and the lower plate of the case 25 to support the shielding plate 45 upward.

Specifically, the support member 50 may support the shielding plate 45 upward to indirectly support the insulating material 35 and the working coil WC upward, and thus, the insulating material 35 may be in close contact with the upper plate 15.

As a result, the interval between the working coil WC and the object HO to be heated may be constantly maintained.

For reference, the support member 50 may include, for example, an elastic body (e.g., a spring) for supporting the shielding plate 45 upward, but is not limited thereto. In addition, since the support member 50 is not an essential component, the support member 50 may be omitted from the induction heating type cooktop 1.

The cooling fan 55 may be installed inside the case 25 to cool the working coil WC.

Specifically, the cooling fan 55 may be controlled to be driven by the above-described control module and may be installed on a sidewall of the case 25. Of course, the cooling fan 55 may be installed at a position other than the sidewall of the case 25, but in the present disclosure, for convenience of explanation, the structure in which the cooling fan 55 is installed on the sidewall of the case 25 will be described as an example.

In addition, as illustrated in FIGS. 2 and 3, the cooling fan 55 may suction air from the outside of the case 25 to deliver the air to the working coil WC or may suction air (particularly, heated air) inside the case 25 to discharge the air to the outside of the case 25.

As a result, efficient cooling of the components (in particular, the working coil WC) inside the case 25 is possible.

Also, as described above, the air outside the case 25 delivered to the working coil WC by the cooling fan 55 may be guided to the working coil WC by the spacers. Thus, the direct and efficient cooling of the working coil WC is possible to improve durability of the working coil WC (i.e., improvement in durability due to prevention of thermal damage).

The intermediate heating body IM may be a material having a resistance value that is capable of being heated by the working coil WC.

FIGS. 4 and 5 are views for explaining a change in impedance between the intermediate heating body and the object to be heated according to kinds of objects to be heated.

A thickness of the intermediate heating body IM may be inversely proportional to the resistance value (i.e., a surface resistance value) of the intermediate heating body IM. That is, as the thickness of the intermediate heating body IM decreases, the resistance value (i.e., surface resistance value) of the intermediate heating body IM increases. Thus, characteristics of the intermediate heating body IM may be changed to a load that may be heated.

For reference, the intermediate heating body IM may have a thickness of, for example, about 0.1 μm to about 1,000 μm, but is not limited thereto.

The intermediate heating body IM having such characteristics may be present to heat the nonmagnetic body, and thus, impedance characteristics between the intermediate heating body IM and the object HO to be heated may be changed according to whether the object HO to be heated disposed on the upper plate 15 is a magnetic body or nonmagnetic body

First, the case in which the object HO to be heated is the magnetic body will be described as follows.

When the magnetic object HO to be heated is disposed on the upper plate 15, and the working coil WC is driven, a resistance component R1 and an inductor component L1 of the object HO to be heated, which has the magnetism as illustrated in FIG. 4) may form an equivalent circuit with a resistance component R2 and an inductor component L2 of the intermediate heating body IM.

In this case, the impedance (i.e., impedance measured by R1 and L1) of the object HO to be heated, which has the magnetism, in the equivalent circuit may be less than that of the intermediate heating body IM (i.e., the impedance measured by R2 and L2).

Thus, when the equivalent circuit as described above is formed, magnitude of the eddy current I1 applied to the magnetic object HO to be heated may be greater than that of the eddy current I2 applied to the intermediate heating body IM. Thus, most of the eddy current generated by the working coil WC may be applied to the object HO to be heated, and thus, the object HO to be heated may be heated.

That is, when the object HO to be heated is the magnetic body, the above-described equivalent circuit may be formed, and thus, most of the eddy current may be applied to the object HO to be heated. As a result, the working coil WC may directly heat the object HO to be heated.

Of course, some eddy current may be also applied to the intermediate heating body IM to slightly heat the intermediate heating body IM, and thus, the object HO to be heated may be indirectly slightly heated by the intermediate heating body IM. In this case, the working coil WC may be a main heating source, and the intermediate heating body IM may be a secondary heating source. However, when compared to a degree of direct heating of the object HO by the working coil WC, a degree of indirect heating of the object HO by the intermediate heating body IM may not be significant.

Next, the case in which the object to be heated is the nonmagnetic body will be described as follows.

When the object HO to be heated, which does not have the magnetism, is disposed on the upper plate 15, and the working coil WC is driven, there is no impedance in the nonmagnetic object HO to be heated, and the intermediate heating body IM may have an impedance. That is, the resistance component R and the inductor component L may exist only in the intermediate heating body IM.

Therefore, when the nonmagnetic object HO to be heated is disposed on the upper plate 15 and the working coil WC is driven, as illustrated in FIG. 5, the resistance component R and the inductor component L of the intermediate heating body IM may form an equivalent circuit.

Thus, eddy current I may be applied only to the intermediate heating body IM, and eddy current may not be applied to the object HO to be heated, which does not have magnetism. More specifically, the eddy current I generated by the working coil WC may be applied only to the intermediate heating body IM, and thus, the intermediate heating body IM may be heated.

That is, when the object HO to be heated is the nonmagnetic body, as described above, the eddy current I may be applied to the intermediate heating body IM to heat the intermediate heating body IM, and the object HO to be heated, which does not have magnetism, may be indirectly heated by the intermediate heating body IM heated by the working coil WC. In this case, the intermediate heating body IM may be a main heating source.

In summary, the object HO to be heated may be directly or indirectly heated by a single heat source, which is called the working coil WC, regardless of whether the object HO is the magnetic body or the nonmagnetic body. That is, when the object HO to be heated is the magnetic body, the working coil WC may directly heat the object HO to be heated, and when the object HO to be heated is the nonmagnetic body, the intermediate heating body IM heated by the working coil WC may indirectly heat the object HO to be heated.

As described above, the induction heating type cooktop 1 according to the embodiment of the present disclosure may heat both the magnetic body and the nonmagnetic body, regardless of the arrangement position and type of the object HO to be heated HO. Thus, the user may place the object to be heated on any heating area on the top plate 15 without needing to determine whether the object HO is the magnetic body or the nonmagnetic body, thereby improving ease of use.

In addition, the induction heating type cooktop 1 according to an embodiment of the present disclosure may directly or indirectly heat the object to be heated with the same heat source, and thus, there is no need to provide a separate heating plate or a radiator heater. Thus, it is possible to not only improve heating efficiency but also reduce material costs.

When the object HO to be heated is the magnetic body, since not only the object HO but also the intermediate heating body IM are heated, there is a limitation in that heating efficiency of the object HO to be heated is slightly lowered. To solve this limitation, when the magnetic fields coupled to the intermediate heating body IM decrease, there is a limitation in that an output of the nonmagnetic object HO be heated is reduced.

Therefore, the cooktop 1 according to an embodiment of the present disclosure may concentrate the magnetic fields to the object HO to be heated when heating the magnetic body and may concentrate the magnetic fields to the intermediate heating body IM when heating the nonmagnetic body.

The present disclosure intends to control the magnetic field concentration area according to the object HO to be heated in the cooktop 1 including the intermediate heating body IM.

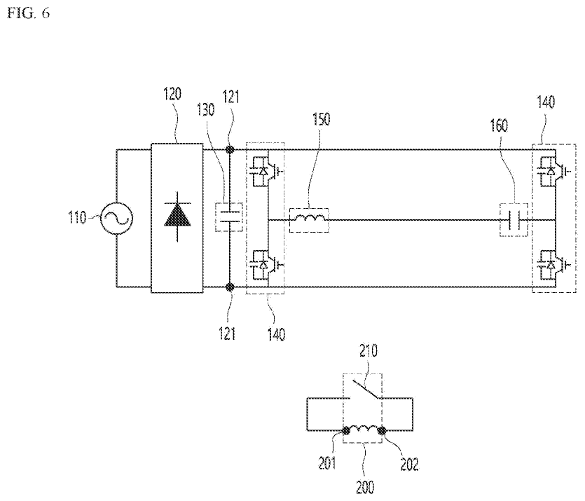

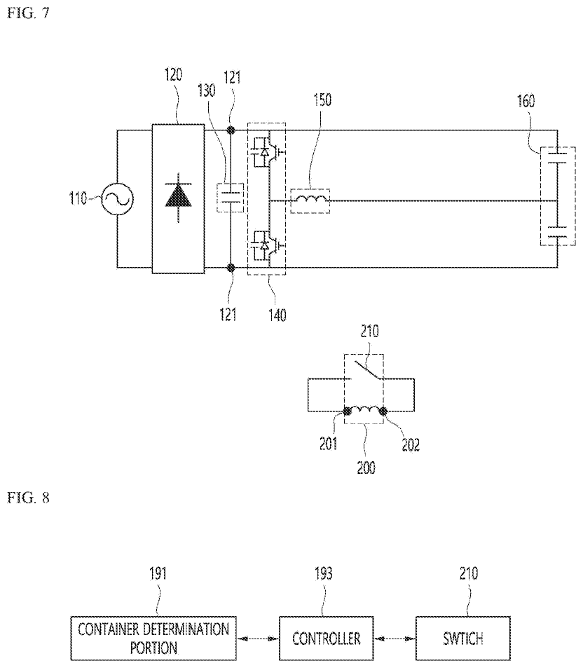

FIGS. 6 and 7 are circuit diagrams of an induction heating type cooktop according to a first embodiment.

In FIGS. 6 and 7, there is only a difference in whether an inverter 140 operates in a half-bridge manner or a full-bridge manner, and the rest is the same. In addition, since a circuit diagram of the cooktop 1 illustrated in FIGS. 6 to 7 is merely illustrative for convenience of description, the embodiment of the present disclosure is not limited thereto.

Referring to FIGS. 6 to 7, a cooktop 1 includes at least some or all of a power supply 110, a rectifier 120, a DC link capacitor 130, an inverter 140, a working coil 150, and a resonance capacitor 160.

The power supply 110 may receive external power. Power received from the outside to the power supply 110 may be alternation current (AC) power.

The power supply 110 may supply an AC voltage to the rectifier 120.

The rectifier 120 is an electrical device for converting alternating current into direct current. The rectifier 120 converts the AC voltage supplied through the power supply 110 into a DC voltage. The rectifier 120 may supply the converted voltage to both DC ends 121.

An output terminal of the rectifier 120 may be connected to both the DC ends 121. Each of both the ends 121 of the DC output through the rectifier 120 may be referred to as a DC link. A voltage measured at each of both the DC ends 121 is referred to as a DC link voltage.

A DC link capacitor 130 serves as a buffer between the power supply 110 and the inverter 140. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 may include a semiconductor switch, and the semiconductor switch may be an insulated gate bipolar transistor (IGBT) or a wide band gab (WBG) device. Since this is merely an example, the embodiment is not limited thereto. The WBG device may be silicon carbide (SIC) or gallium nitride (GaN). The inverter 140 drives the semiconductor switch to allow the high-frequency current to flow in the working coil 150, and thus, high-frequency magnetic fields are generated in the working coil 150.

In the working coil 150, current may or may not flow depending on whether the switching device is driven. When current flows through the working coil 150, magnetic fields are generated. The working coil 150 may heat an cooking appliance by generating the magnetic fields as the current flows.

The working coil 150 is the same as the working coil WC illustrated in FIGS. 1 to 3. That is, in this specification, a reference numeral indicating the working coil is used interchangeably with reference numeral 150 and reference symbol WC.

One side of the working coil 150 is connected to a connection point of the switching device of the inverter 140, and the other side is connected to the resonance capacitor 160.

The switching device is driven by a driver (not shown), and a high-frequency voltage is applied to the working coil 150 while the switching device operates alternately by controlling a switching time output from the driver. In addition, since a turn on/off time of the switching device applied from the driver (not shown) is controlled in a manner that is gradually compensated, the voltage supplied to the working coil 150 is converted from a low voltage into a high voltage.

The resonance capacitor 160 may be a component to serve as a buffer. The resonance capacitor 160 controls a saturation voltage increasing rate during the turn-off of the switching device to affect an energy loss during the turn-off time.

Also, as illustrated in FIGS. 6 to 7, the cooktop 1 may further include a shielding coil 200.

The shielding coil 200 may serve to offset the magnetic fields generated by the working coil 150. Thus, the shielding coil 200 may suppress heat generation of the intermediate heating body IM.

The shielding coil 200 may be disposed between the upper plate 15 and the working coil WC. Other configurations other than the shielding coil 200 may be further disposed between the upper plate 15 and the working coil WC. That is, the shielding coil 200 is disposed not only under the upper plate 15 and immediately above the working coil WC, but also between the upper plate 15 and the working coil WC with other configurations.

In the shielding coil 200, current may be selectively induced according to the type of the object HO to be heated. That is, the induced current may or may not flow in the shielding coil 200 depending on the type of the object HO to be heated.

The cooktop 1 may further include a switch 210 connected to the shielding coil 200. The switch 210 may be configured to selectively induce the current to the shielding coil 200

The switch 210 may be connected to each of one end 201 and the other end 202 of the shielding coil 200. The switch 210 may control a circuit to which the shielding coil 200 is connected as a closed circuit or an open circuit.

For example, the switch 210 is turned on when the object HO to be heated is the magnetic body, and thus, the induced current may flow in the shielding coil 200. That is, when the object HO to be heated is the magnetic body, the induced current may flow through the shielding coil 200. When the object HO to be heated is the magnetic body, the circuit to which the shielding coil 200 is connected may form the closed circuit. In addition, the induced current is generated in a direction in which a change of the magnetic fields are offset, and when the object HO to be heated HO is the magnetic body, the shielding coil 200 may generate magnetic fields that are offset by the magnetic fields generated in the working coil 150. That is, the shielding coil 200 may be disposed between the working coil WC and the intermediate heating body IM, and the magnetic fields generated in the shielding coil 200 may be generated in the working coil WC so as to be offset by the magnetic fields passing through the intermediate heating body IM. Thus, the magnetic fields generated in the working coil WC may be concentrated to the object HO to be heated. That is, when the object HO to be heated is the magnetic body, the magnetic field concentration area may be provided on the object HO to be heated.

The switch 210 may be turned off when the object HO to be heated is the nonmagnetic body, and thus, the current may not be induced in the shielding coil 200. That is, when the object HO to be heated is the nonmagnetic body, the induced current may not flow in the shielding coil 200. When the object HO to be heated is the non-magnetic body, the circuit to which the shielding coil 200 is connected may form an open circuit. Thus, since no magnetic fields are generated in the shielding coil 200, the magnetic fields generated in the working coil WC may be concentrated to the intermediate heating body IM. That is, when the object HO to be heated is the nonmagnetic body, the magnetic field concentration area may be formed on the intermediate heating body IM.

FIG. 8 is a control block diagram illustrating a method for controlling a switch depending on an object to be heated in an induction heating type cooktop according to an embodiment.

FIG. 8 exemplarily illustrates only components that are necessary to explain an operation method of the cooktop 1 according to the object HO to be heated, and some of the components illustrated in FIG. 8 may be omitted, or other components that are not illustrated in FIG. 8 may be further provided.

The cooktop 1 may include a container determination portion 191, a controller 193, and a switch 210.

The container determination portion 191 may determine the type of the object HO to be heated, that is, the type of the cooking container. The container determination portion 191 may determine a material of the object HO to be heated. In summary, the container determination portion 191 may acquire the type of the object HO to be heated or the material of the object HO to be heated. The type of the object HO to be heated may be a concept including the material of the cooking container. A method for determining the type of the object to be heated through the container determination portion 191 may vary.

The controller 193 may control the switch 210 according to the type of the object HO to be heated, which is determined by the container determination portion 191.

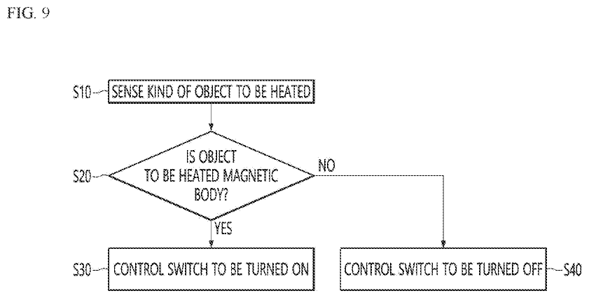

FIG. 9 is a flowchart illustrating a method for controlling the switch according to the object to be heated in the induction heating type cooktop according to an embodiment.

The container determination portion 191 may sense the type of the object HO to be heated (S10).

The controller 193 may control the container determination portion 191 to sense the type of the object HO to be heated.

The controller 193 may determine whether the object HO to be heated is the magnetic body (S20).

The controller 193 may determine whether the object HO to be heated is the magnetic body or the nonmagnetic body, based on the sensed result of the container determination portion 191.

If the object HO to be heated is the magnetic body, the controller 193 may control the switch 210 to be turned on (S30).

Also, if the object HO to be heated is the nonmagnetic body, the controller 193 may control the switch 210 to be turned off (S40).

Alternatively, if the object HO to be heated is not the magnetic body, the controller 193 may control the switch 210 to be turned off.

When the working coil WC is provided in plurality, when the plurality of working coils WC are phase-controlled, the direction of the magnetic fields are not constant. Thus, the shielding coil 200 may be provided to surround the plurality of working coils WC to selectively operate according to phases in the plurality of working coils WC.

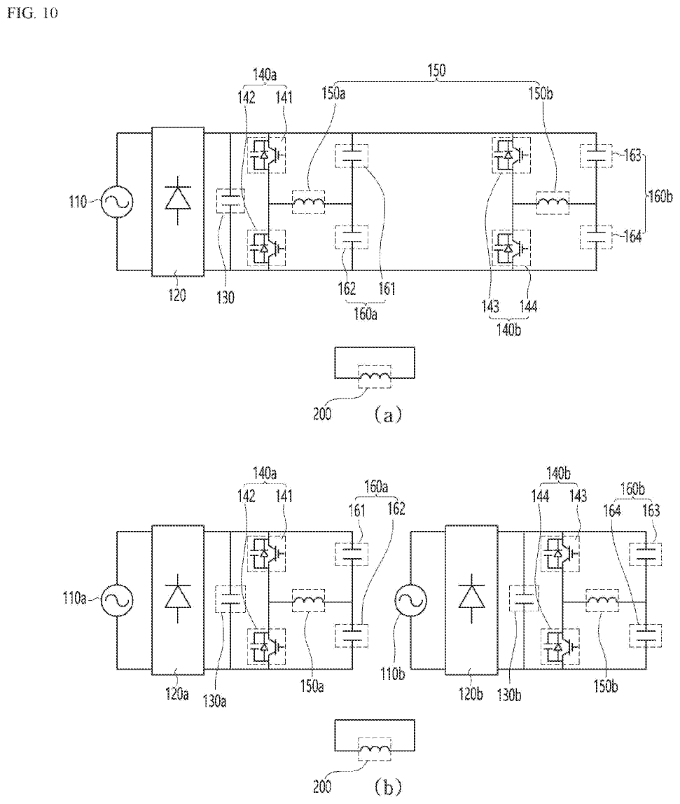

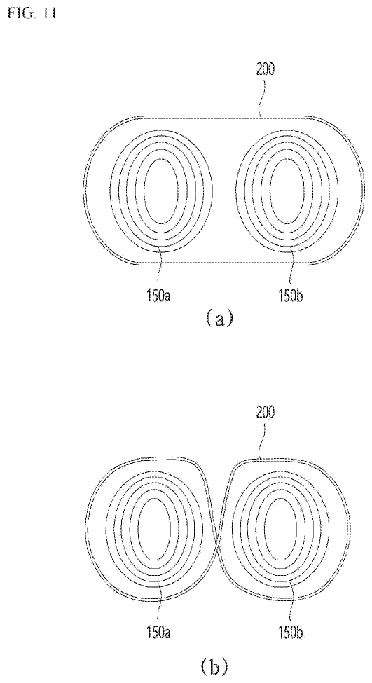

First, FIG. 10 is a circuit diagram of the induction heating type cooktop according to a second embodiment.

An induction heating type cooktop 1 according to a second embodiment may include a plurality of working coils 150. The cooktop 1 may be driven by each of two inverters 140a and 140b.

The cooktop 1 according to the second embodiment may include at least some or all of a power supply 110, a rectifier 120, a DC link capacitor 130, inverters 140a and 140b, working coils 150a and 150b, resonance capacitors 160a and 160b, and a shielding coil 200.

The power supply 110, the rectifier 120, and the DC link capacitor 130 are the same as described with reference to FIGS. 6 to 7.

The inverters 140a and 140b, the working coils 150a and 150b, and the resonance capacitors 160a and 160b are provided in plurality and are the same as described above except that the inverters 140a and 140b, the working coils 150a and 150b, and the resonance capacitors 160a and 160b control the working coils 150a and 150b, respectively.

(a) of FIG. 10 illustrates an embodiment in which power is supplied from the same power supply 110, and (b) of FIG. 10 illustrates an embodiment in which power is supplied through different power supplies 110a and 110b. The power supplies 110a 110b, the rectifiers 120a and 120a, and the DC link capacitors 130a and 130a may also be provided separately.

The cooktop 1 according to the second embodiment is not limited to the configuration illustrated in FIG. 10 and may include a cooktop 1 including a plurality of working coils 150 to enable phase control.

The shielding coil 200 of the cooktop 1 according to the second embodiment may be formed as a single closed circuit. In addition, the shielding coil 200 may be disposed to surround the plurality of working coils 150a and 150b.

FIG. 11 is a view illustrating a state in which the shielding coil is disposed in the induction heating type cooktop according to the second embodiment.

According to the second embodiment, the working coil 150 may include a first working coil 150a and a second working coil 150b that are arranged parallel to each other at left and right sides, and the inverter 140 may control current flowing through the first working coil 150a and the second working coil 150b.

When the plurality of working coils 150a and 150b are arranged parallel to each other, the plurality of working coils 150a and 150b may operate in the same phase when a nonmagnetic body is heated and may operate in opposite phases when a magnetic body is heated.

The shielding coil 200 is disposed in a shape in which induced current flows when current having the same phase flows in the first working coil 150a and the second working coil 150b as illustrated in (a) of FIG. 11, or the shielding coil 200 is disposed in a shape in which an induced current flows when current having opposite phases flow in the first working coil 150a and the second working coil 150b as illustrated in (b) of FIG. 11.

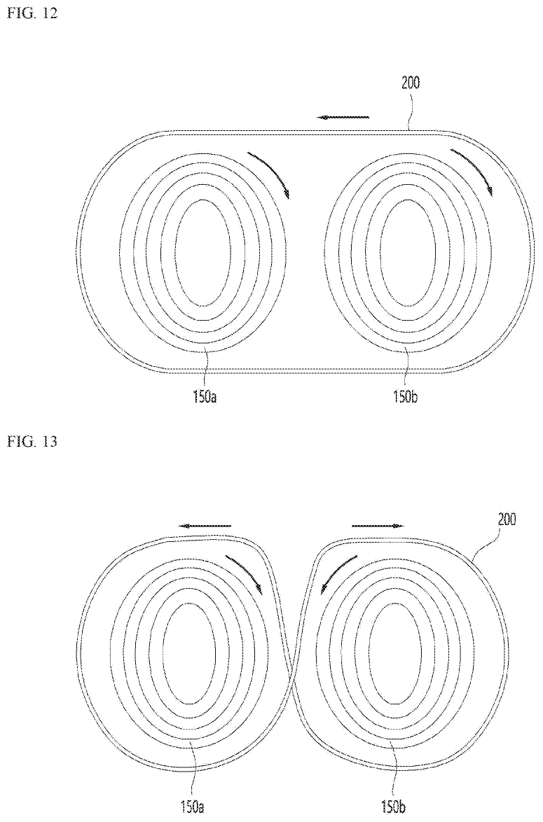

First, a case in which the shielding coil 200 is disposed as illustrated in (a) of FIG. 11 will be described in detail with reference to FIG. 12.

FIG. 12 is a view illustrating a state in which the current is induced to the shielding coil when the shielding coil is disposed as illustrated in (a) of FIG. 11.

The shielding coil 200 may be disposed outside the first working coil 150a and the second working coil 150b so that the first working coil 150a and the second working coil 150b are disposed inside the shielding coil 200.

In this case, when the first working coil 150a and the second working coil 150b operate in opposite phases, no current is induced in the shielding coil 200. That is, when the first working coil 150a and the second working coil 150b operate in opposite phases, the shield coil 200 does not operate.

When the first working coil 150a and the second working coil 150b operate in the same phase, the shielding coil 200 may operate in a phase opposite to the phase. For example, when the current flows in each of the first working coil 150a and the second working coil 150b in a clockwise direction, the current may be induced in the shielding coil 200 in a counterclockwise direction.

Thus, the shielding coil 200 illustrated in FIG. 12 may not generate magnetic fields when the cooktop 1 heats the magnetic body and may generate magnetic fields only when the cook top 1 heats the nonmagnetic body.

That is, the shielding coil 200 may offset external magnetic fields when the first and second working coils 150a and 150b operate in the same phase, and thus, leakage of the magnetic fields generated in the first and second working coils 150a and 150b outward may be minimized. That is, the magnetic fields generated in the shielding coil 200 may be offset by the magnetic fields leaking out of a heating area. The shielding coil 200 may not operate when the magnetic body is heated and may acquire a phase control effect by minimizing the leakage of the magnetic fields when the nonmagnetic body is heated.

Next, a case in which the shielding coil 200 is disposed as illustrated in (b) of FIG. 11 will be described in detail with reference to FIG. 13.

FIG. 13 is a view illustrating a state in which current is induced to the shielding coil when the shielding coil is disposed as illustrated in (b) of FIG. 11.

The shielding coil 200 may be disposed around the first working coil 150a and the second working coil 150b to surround the first working coil 150a and the second working coil 150b so that the shield coil 200 crosses at least once between the first working coil 150a and the second working coil 150b. The shielding coil 200 may be disposed so that the induced current passes through an outer circumference of the first working coil 150a to flow along an outer circumference of the second working coil 150b.

In this case, when the first working coil 150a and the second working coil 150b operate in the same phase, no current is induced in the shielding coil 200. That is, when the first working coil 150a and the second working coil 150b operate in the same phase, the shield coil 200 does not operate.

That is, when the first working coil 150a and the second working coil 150b operate in opposite phases, the shield coil 200 may operate. For example, when the current flows to the first working coil 150a in the clockwise direction, and the current flows to the second working coil 150b in the counterclockwise direction, in the shielding coil 200, the current may be induced in the counterclockwise direction around the first working coil 150a and may be induced in the clockwise direction around the second working coil 150b.

Thus, the shielding coil 200 illustrated in FIG. 12 may not generate magnetic fields when the cooktop 1 heats the nonmagnetic body and may generate magnetic fields only when the cook top 1 heats the magnetic body.

That is, the shielding coil 200 may further offset external magnetic fields when the first and second working coils 150a and 150b operate in opposite phases and may reduce an amount of heat generated in the intermediate heating body IM by the offset amount of magnetic fields to more concentrate the magnetic fields to the object HO to be heated, thereby minimizing a phase control effect. In addition, since the shielding coil 200 does not operate when heating the nonmagnetic body, it may have no effect on heating performance of the nonmagnetic body.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1. An induction heating type cooktop comprising:
an upper plate, on which an object to be heated is disposed;
an intermediate heating body installed on the upper plate;
a working coil configured to generate magnetic fields for heating the object to be heated;
an inverter driven to supply current to the working coil; and
a shielding coil in which the current is selectively induced according to kinds of object to be heated.

2. The induction heating type cooktop according to claim 1, wherein, when the object to be heated is a magnetic body, the inducted current flows in the shielding coil.

3. The induction heating type cooktop according to claim 1, wherein, when the object to be heated is a magnetic body, the shield coil is configured to generate magnetic fields that are offset by the magnetic fields generated in the working coil.

4. The induction heating type cooktop according to claim 1, wherein, when the object to be heated is a nonmagnetic body, the current is not induced in the shielding coil.

5. The induction heating type cooktop according to claim 1, further comprising a switch configured to selectively induce the current into the shielding coil.

6. The induction heating type cooktop according to claim 5, wherein the switch is connected to each of one end and the other end of the shielding coil.

7. The induction heating type cooktop according to claim 6, wherein the switch is turned on when the object to be heated is a magnetic body, and
the switch is turned off when the object to be heated is a nonmagnetic body.

8. The induction heating type cooktop according to claim 1, wherein the working coil comprises a first working coil and a second working coil, which are disposed parallel to each other in a left and right direction, and
the inverter is configured to control current flowing in the first working coil and the second working coil.

9. The induction heating type cooktop according to claim 8, wherein the shielding coil is disposed in a shape in which the induced current flows when current having the same phase flows in the first working coil and the second working coil.

10. The induction heating type cooktop according to claim 9, wherein the shielding coil is disposed outside the first working coil and the second working coil so that the first working coil and the second working coil are disposed inside the shielding coil.

11. The induction heating type cooktop according to claim 9, wherein the magnetic fields generated in the shielding coil are offset by the magnetic fields that leak out of a heating area.

12. The induction heating type cooktop according to claim 8, wherein the shielding coil is disposed in a shape in which the induced current flows when current having an out-of-phase flows in the first working coil and the second working coil.

13. The induction heating type cooktop according to claim 12, wherein the shielding coil is disposed so that the induced current passes through an outer circumference of the first working coil to flow along an outer circumference of the second working coil.

14. The induction heating type cooktop according to claim 12, wherein the magnetic fields generated in the shielding coil are offset by the magnetic fields generated in the working coil to pass through the intermediate heating body.

15. The induction heating type cooktop according to claim 1, wherein the shielding coil is disposed between the upper plate and the working coil.
